(19) United States
(12) Patent Application Publication
(10) Pub. No.: US 2026/0233278 A1
(43) Pub. Date: Aug. 13, 2026

(54) A SCREW EXTRUDER AND A METHOD OF CONTROLLING EXTRUSION PRESSURE IN A SCREW EXTRUDER

(71) Applicant: Circmet AS, Oslo (NO)

(72) Inventors: Øyvind NIELSEN, Tårnåsen (NO); Idar Kjetil STEEN, Sunndalsøra (NO); Jens Christofer WERENSKIOLD, Trondheim (NO)

(21) Appl. No.: 19/160,010

(22) PCT Filed: Feb. 27, 2024
(86) PCT No.: PCT/NO2024/050048

§ 371 Date: Aug. 26, 2025

(30) Foreign Application Priority Data
Feb. 28, 2023 (NO) 20230198

(51) Int. Cl. B21C 23/00; B21C 27/00; B21C 29/02; B30B 11/24; B30B 15/34

(52) U.S. Cl. CPC B21C 23/005; B21C 27/00; B21C 29/02; B30B 11/246; B30B 15/34

(57) ABSTRACT

A screw extruder for extrusion of materials with high viscosity, including a screw rotationally arranged in a bore within a housing. The housing includes a base section having a material feed inlet, an extrusion section having a compacting chamber and an extrusion die opening, and one or more transport and compaction sections arranged between the base section and the extrusion section. At least one of the housing sections includes one or more fluid conduits and one or more fluid connectors for connection to a fluid supply and circulation system, whereby the temperature in the at least one housing section may be controlled individually.

### TECHNICAL FIELD

The invention concerns a screw extruder for extrusion of materials with high viscosity, for example metals such as aluminium or aluminium alloys, or other metal matrix composites or alloys. More specifically, the invention concerns a screw extruder as set out by the preamble of claim 1, and a method of controlling extrusion pressure in a screw extruder as set out by the preamble of claim 12.

### BACKGROUND

The prior art includes US 2007/121421 A1, which describes a multiple-shaft extruder having a core with outward leading channels for a cooling liquid. At least two housing segments are each provided with a cooling circuit with interconnected cooling bore holes for a cooling liquid, distributed in the peripheral direction and in an axially parallel manner, and which are located on the section of the housing segments that faces the process chamber. The housing segment provided with the cooling bores has at the same time a heating means on the outside circumference. Each housing segment provided both with cooling bores and with a heating means preferably has a control device which controls both the heating means and the flow of cooling liquid through the cooling bores to permit adjustment of an optimal processing temperature and a material temperature as low as possible.

The prior art also includes US 10 035 291 B2, which describes a device for lateral flow charging of an extruder in which material is fed to at least one conveyor screw disposed in an extruder housing. The material contains gaseous concomitant materials, wherein a degassing housing for receiving an air flow is disposed on the extruder housing, which air flow acts in the extruder housing and which is directed contrary to the conveying direction of the conveyor screw.

The prior art also includes DE 10 356 423 B4, which describes an extruder barrel made up of connected sections with a liner to accommodate channels for a temperature control fluid. Entries for feed or additive material are provided in the side between the section joints. The entry ports have a widened section, which houses a bush with annular grooves to provide a passage for the temperature control fluid. Several grooves can be used and the total cross-sectional area is preferably not reduced by more than 10% from the flow area available for the temperature control fluid in the rest of the extruder. The side feed can come from a pump or a side extruder, e.g. a twin-screw extruder.

Publications US 3 199 147 A and CN 211 074 655 U also describe various extruder types.

The prior art also includes WO 2008/063076 A1, which describes a screw extruder for the continuous extrusion of materials with high viscosity, in particular metals such as aluminium and its alloys. The extruder includes an Archimedes screw rotationally provided within liner of a screw housing with an inlet for the feeding of the material to be extruded, a compacting or extrusion chamber, and an extrusion die assembly with a die which forms the shape of the desired extruded product. The design of the screw and liner is such that the required compaction takes place at the downstream end of the screw towards the extrusion chamber corresponding to up to 540° of the rotation of the screw, or up to 1,5 turns of the screw flight length, and that the solid plug of metal thus formed at the end of the screw and extrusion chamber is restricted from rigid rotation to obtain the required compaction and extrusion pressure.

FIG. 1 is a schematic illustration of general principles of a screw extruder. A screw 51 is arranged in a bore 55 inside an extruder housing (also referred to as a “barrel”) 50. The matter to be extruded is fed into a feeding zone F through an inlet 52. The matter—which may comprise a mixture of substances—is conveyed along the bore by the rotating screw, through a heating and mixing zone M, before the mixture is compressed in a compaction zone C and then forced into an extrusion chamber 53 and extruded through an extrusion die 54.

A critical parameter for successful operation of a screw extruder for extrusion of materials with high viscosity, is the temperature along the screw housing, or more specifically: along the bore in which the extruder screw is arranged. Efficient screw extrusion of such materials (e.g. aluminium) requires specific temperatures along the screw. High temperatures in the forward region (i.e. near the extrusion chamber 53) will promote sticking friction and reduce forces required for material deformation, while limited temperature further back (i.e. near the inlet 51) will prevent sticking friction and material compaction. The ability to control the temperature gradient along the extruder bore is therefore necessary in order to avoid these problems. An objective of the present invention is to improve the cooling capability to provide a robust and stable extrusion process.

There is a need for a device and a method whereby friction along the barrel—and hence the extrusion pressure—may be controlled more precisely than what is possible with the prior art extruders, and where the quality and throughput may be further optimised.

### SUMMARY

The invention is set forth and characterized in the main claim, while the dependent claims describe other characteristics of the invention.

It is thus provided a screw extruder for extrusion of materials with high viscosity, such as aluminium, aluminium alloys, or other metal matrix composites or alloys, comprising a screw rotationally arranged in a bore within a housing,
wherein the housing comprises a base section having an inlet for feeding material into the extruder, and an extrusion section having a compacting chamber and an extrusion die opening;
wherein the screw extruder is characterized by
one or more transport and compaction sections arranged between the base section and the extrusion section, and the housing sections are releasably interconnected in an end-to-end relationship.

In one embodiment, at least one gap is provided between at least two adjacent housing sections, wherein the at least one gap is a void or holds an insulating material, whereby heat transfer between adjacent housing sections is limited. In one embodiment, at least one gap holds an element having a thermal conductivity that is equal to or greater than the thermal conductivity of the material in the housing sections, whereby heat transfer between adjacent housing sections is enhanced.

At least one of the housing sections may comprise one or more fluid conduits and one or more fluid connectors for connection to a fluid supply and circulation system, whereby the temperature in said at least one housing section may be controlled individually. In one embodiment, the one or more fluid conduits are embedded in the at least one housing section.

In one embodiment, at least one transport and compaction section comprises an outer body having an internal liner arranged in an internal bore of the outer body and at least a portion of said extruder bore is formed in the liner. In one embodiment, the liner material has a thermal conductivity which is greater than the thermal conductivity of the outer body material.

The liner is preferably secured to the outer body whereby the liner is prevented from rotating inside the outer body. In one embodiment, the outer body inner surface and the liner outer surface have complementary shapes. In one embodiment, the outer body inner surface and the liner outer surface have complementary frustoconical shapes with a common cone angle and the liner comprises a frustrum with its base on the downstream side of the section.

In one embodiment, the liner outer surface comprises a helical groove that forms a fluid conduit when the insert is arranged in the outer body, and wherein channels terminating in external fluid connectors are formed in the outer body and aligned with the respective ends of the helical grove when the insert is arranged in the outer body.

It is also provided a method of controlling extrusion pressure in a screw extruder for extrusion of a material or materials with high viscosity, such as aluminium, aluminium alloys, or other metal matrix composites or alloys, wherein the screw extruder comprises a screw rotationally arranged in a bore within a housing,
characterized in that the method comprises controlling the temperature in the screw and the temperature in the wall of the bore while the screw is rotating and the material or materials are within a mixing-and-compaction zone in the extruder, such that the temperature in the screw is higher than the temperature of the wall of the bore.

In one embodiment, the method comprises allowing at least the temperature in the wall of the bore to rise to a level at or above the sticking friction temperature for the material or materials to be extruded, at the beginning of the mixing-and-compaction zone, while maintaining the temperature in the screw above the temperature of the wall of the bore.

In one embodiment of the method, the screw extruder comprises an extruder according to the invention and as specified above. In one embodiment, the method comprises controlling the temperature in each housing section individually, by circulating a fluid in at least one fluid conduit in the respective housing section, and the fluid is a cooling liquid and the temperature of the cooling liquid fed into the fluid conduit is based on one or more temperatures sensed in the respective housing section.

The improved extrusion pressure control made possible by the invention, allows for an improved extrusion efficiency, i.e., optimisation of the relationship between extruded volume and energy consumption.

### BRIEF DESCRIPTION OF THE DRAWINGS

These and other characteristics of the invention will become clear from the following description of embodiments of the invention, given as non-restrictive examples, with reference to the attached schematic drawings, wherein:

FIG. 1 is a schematic side view of a screw extruder according to the prior art.

FIG. 2 is a perspective view of an embodiment of the extruder according to the invention;

FIG. 3 is an axial cross-sectional view of an embodiment of the extruder according to the invention;

FIG. 4 is an axial cross-sectional view of another embodiment of the extruder according to the invention (the extrusion screw illustrated without flights);

FIG. 5a is an axial cross-sectional view of the embodiment of the extruder illustrated in FIG. 4, but with extruder screw removed;

FIG. 5b is an enlarged view of the area “A” in FIG. 5a;

FIG. 6a is similar to FIG. 5a, and FIG. 6b is an enlarged view of the area “B” in FIG. 6a;

FIG. 7 is a perspective x-ray view of an embodiment of a base barrel, illustrating internal cooling conduits;

FIG. 8 is an elevation view of an embodiment of an intermediate housing section, seen in the extruder axial direction;

FIG. 9 is a perspective x-ray view of an embodiment of an intermediate housing section, illustrating internal cooling conduits;

FIG. 10 is a perspective x-ray view of an embodiment of a compaction housing section, illustrating internal cooling conduits

FIG. 11 is a perspective view of an alternative embodiment of an intermediate housing section, comprising an inner liner;

FIG. 12 is an elevation view of the housing section illustrated in FIG. 11; and

FIG. 13 is an exemplary diagram illustrating friction force and shear strength as functions of temperature.

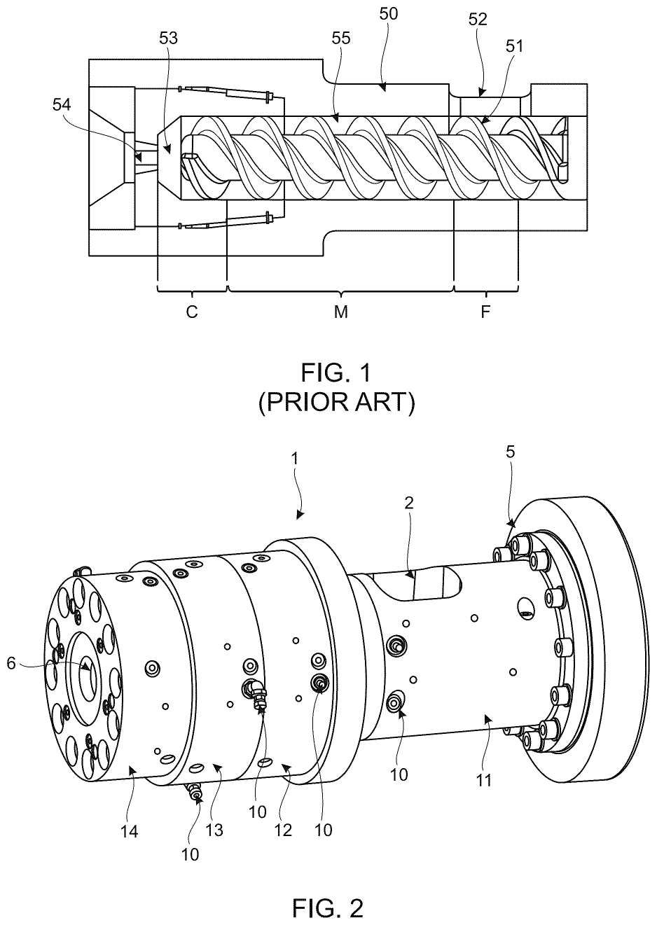

### DETAILED DESCRIPTION OF EMBODIMENTS

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

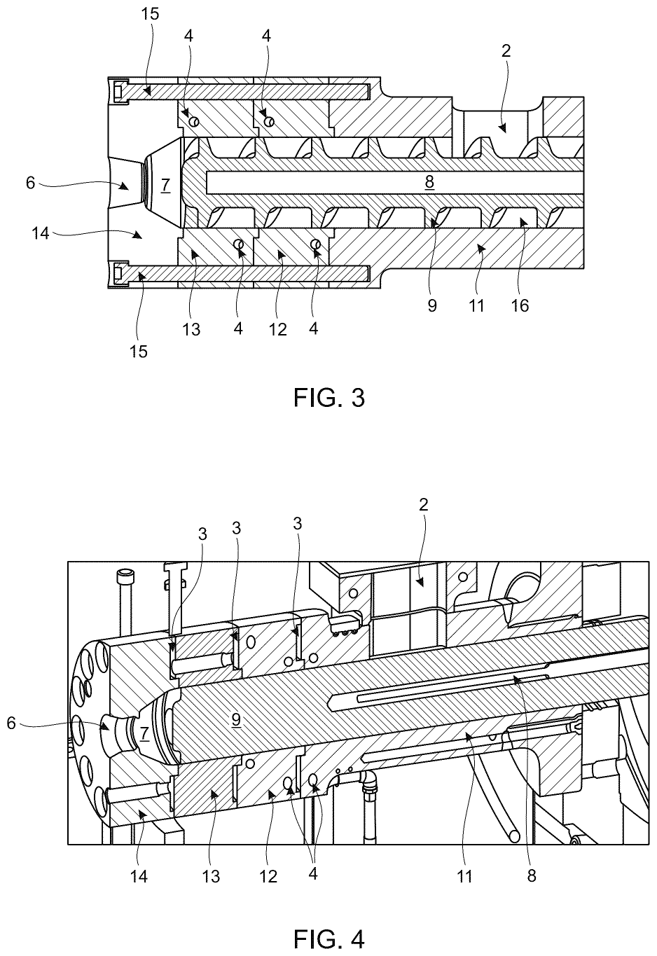

Referring initially to FIGS. 2 and 3, the invention comprises a screw extruder 1 for extrusion of materials with high viscosity, for example metals such as aluminium or aluminium alloys. The screw extruder comprises a screw 9 rotationally arranged in a bore 16 within a housing. The screw 9 may be an Archimedes screw or any other screw device suitable for extrusion purposes, and is powered (rotated) by a motor and control equipment (not shown) commonly known in the art. The extruder is connected to a control-and-drive unit (not shown) via a flanged connection 5 and connected to a fixed support in a manner known in the art. Reference number 4 denotes fluid conduits and reference number 10 a connector to the fluid conduit, as discussed below.

The housing—also referred to as a “barrel”—comprises a plurality of interconnected housing sections 11-14 arranged in an end-to-end relationship.

A proximal housing section (also referred to as a “base section”) 11 is located in front of the driveline (not shown) and comprises an inlet 2 (material feed opening) for receiving the material to be compacted and extruded, and a portion of the above-mentioned bore 16.

A distal housing section (also referred to as an “extrusion section”) 14 is arranged in a region of the downstream end of the screw 9 and bore 16 and comprises a compacting chamber 7 and an extrusion die opening 6 which is configured to form the shape of the extruded product.

A plurality of intermediate housing sections (also referred to as “transport and compaction sections”) 12, 13 are arranged between the base section 11 and the extrusion section 14; each intermediate housing section comprising a portion of the above-mentioned bore 16. The figures illustrate two transport and compaction sections 12, 13, but the screw extruder may comprise more or fewer such sections.

The housing sections are interconnected via bolts or screws 15, or similar, which connect the sections to a fixed support and facilitate easy replacement and refurbishment of screw and housing sections, as well as adding more intermediate housing sections. The housing sections are made of materials known in the art and which are suited for the intended purpose.

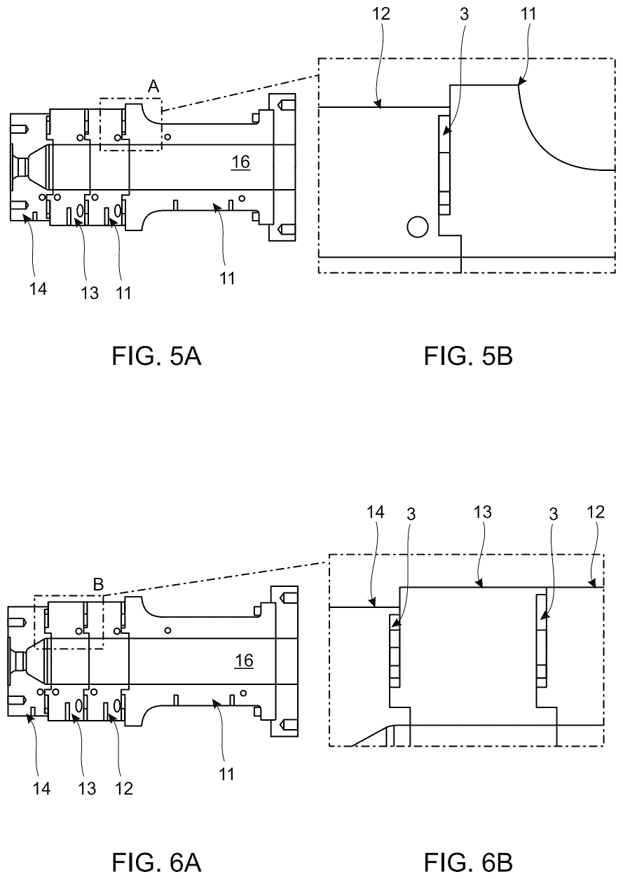

Referring additionally to FIGS. 4-6, in one embodiment a gap 3 is provided between adjacent housing sections. The gap may be a void or hold an insulating material (not shown), in order to limit heat transfer between adjacent housing sections. Alternatively—in order to enhance heat transfer between adjacent housing sections, the gap holds an element (not shown) having a thermal conductivity that is equal to or greater than the thermal conductivity of the material in the housing sections.

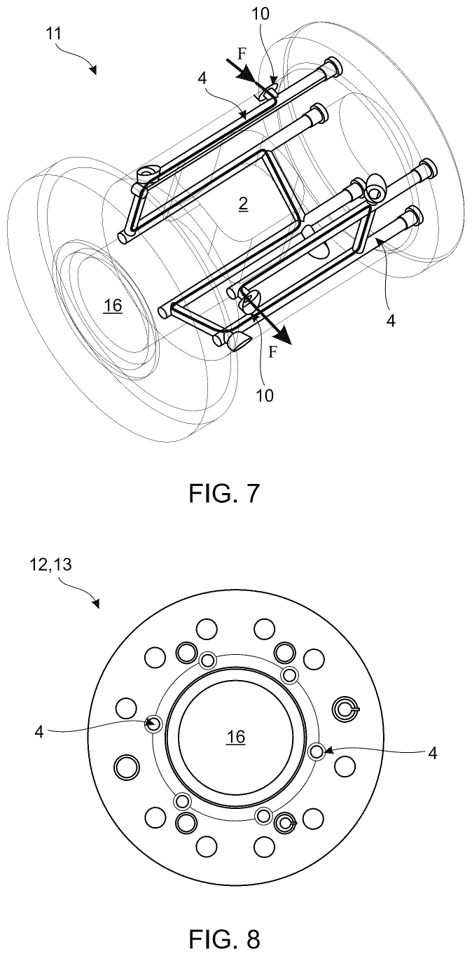

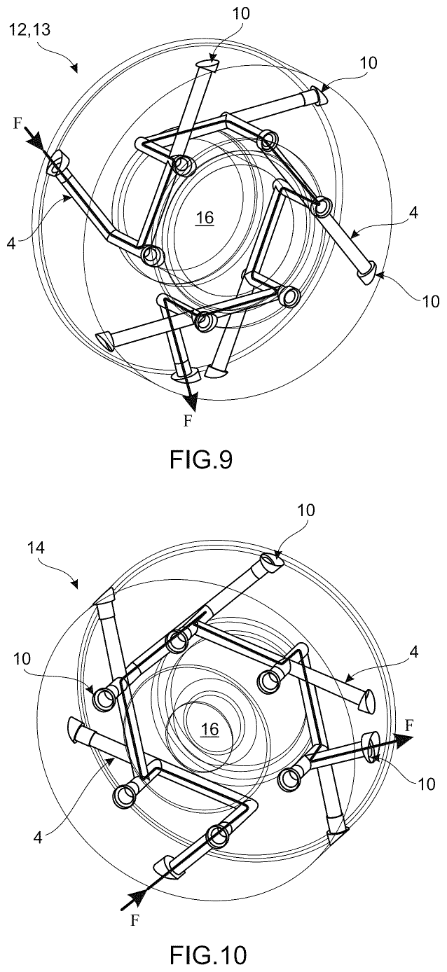

Referring additionally to FIG. 7, the base section 11 comprises fluid conduits 4, preferably one on each side of the inlet 2. Arrows F indicate fluid flow through the conduits, and reference number 10 indicates connectors for connection to a cooling fluid supply and circulation system (not shown). The cooling fluid supply and circulation system is connected to a control unit (not shown). FIGS. 8 and 9 illustrate fluid conduits 4 and connectors 10 in the transport and compaction sections 12, 13, and FIG. 10 illustrates fluid conduits 4 and connectors 10 in the extrusion section 14.

As the fluid conduits 4 are embedded in the housing sections and not in a separate external liner, the fluid conduits are arranged close to the bore 16 (see e.g. FIGS. 3 and 8). Such close proximity between fluid conduits and bore facilitates an improved cooling power and a faster response, compared to the prior art cooling systems.

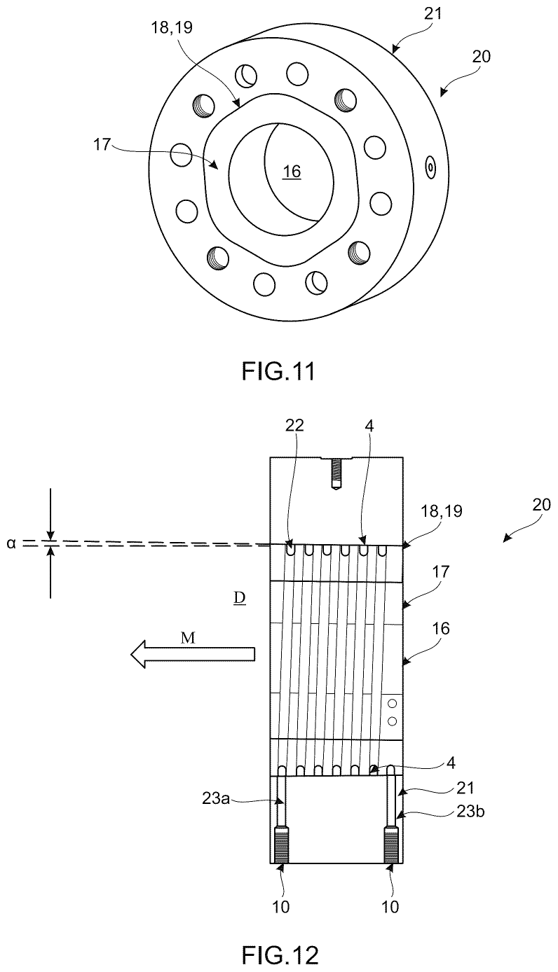

When the extruder is in operation, the housing sections 12, 13 are exposed to severe heat generation from the deformation of the extrudate. The heat flow from the housing to the cooling channels is limited by the thermal conductivity of the housing material, and thermal runaway will cause thermal stress that may cause plastic deformation and/or formation of cracks in the extruder bore 16. This problem is mitigated or even avoided by the invention, by incorporating an internal liner having a material with thermal conductivity sufficiently high for transporting away the generated heat. FIGS. 11 and 12 thus illustrate an alternative embodiment of the above-mentioned intermediate housing section 12, 13, denoted by reference number 20. The housing section 20 comprises an outer body 21 and an internal liner 17. The internal liner 17 is arranged in an internal bore of, and coaxially with, the outer body 20. The above-mentioned extruder bore 16 is formed in the liner 17. The liner material has a thermal conductivity which is greater than the thermal conductivity of the outer body material. As a non-limiting example, the thermal conductivity of the liner 17 is in the region 40 to 80 W/(m K), while the thermal conductivity of the outer body 20 is around 25 W/(m K). As a non-limiting example, the liner 17 material is a high-thermal conductive steel or beryllium copper, and the outer body 20 material is regular tool-grade steel.

The liner 17 is subjected to torsion by the material being extruded, caused by the torque induced by the rotating extruder screw, and is therefore secured to the outer body 21 in order to prevent the liner from rotating inside the outer body (the outer body being fixed to a support as mentioned above). In the embodiment illustrated in FIG. 11, the outer body 21 inner surface 18 and the liner 17 outer surface 19 have complementary shapes, whereby the liner is prevented from rotating inside the outer body. In the illustrated embodiment, the surfaces 18, 19 are undulating radially, with six lobes. It should be understood that these surfaces may have other shapes.

Referring to FIG. 12, the surfaces 18, 19 have complementary frustoconical shapes with a common cone angle α. The liner 17 is thus a frustrum with its base on the downstream side D of the section 20 (letter “M” designating the flow direction of the material being extruded). This configuration ensures a press-fit between liner and outer body and prevents inadvertent separation when the section 20 is removed from the extruder. In the illustrated embodiment, the liner 17 outer surface comprises a helical groove 22 that forms the above-mentioned fluid conduit 4 when the insert is arranged in the outer body 21 are shown in FIG. 12. Channels 23a, b are formed in the outer body and are aligned with the respective ends of the helical grove 22 when the insert is arranged in the outer body, and terminate in respective fluid connectors 10.

For all of the embodiments described above, the cooling fluid to be circulated in the fluid conduits 4 may be a liquid, such as water. The cooling liquid may be water with additives to raise the boiling temperatures, or any other suitable cooling liquid. The cooling fluid may also be a gas, such as air or other mixture of gases. In one embodiment, a cooling liquid is used to control the temperature in the base section 11 and/or in the transport and compaction sections 12, 13; 20, while a gas (such as air) is used for controlling the temperature in the extrusion section 14.

As each of the housing sections 11-14; 20 comprises connectors 10 for external supply and circulation of a cooling fluid, the temperature of each housing section may be controlled individually. During operation of the extruder, the coolant temperature is controlled in order to control the temperature of the respective housing section, and hence the friction between the bore wall and the material.

In one embodiment, illustrated in FIGS. 3 and 4, the screw 9 comprises an internal, axial fluid conduit (8) connected to a fluid supply and circulation system (not shown), whereby a cooling fluid may be circulated in the screw.

Although not illustrated, it will be understood that the housing sections comprise temperature sensors and means for transmitting sensor data to the above-mentioned control unit.

Although not illustrated, the housing section bore 16 may comprise a coating to reduce sticking friction towards the material.

A fundamental difference between polymer extrusion and metal extrusion is that in polymers, the friction force is the product of the applied pressure multiplied by the friction coefficient multiplied by the area; i.e., the frictional force in a polymer is proportional to the pressure. For metals that exhibit sticking friction, such as aluminium, the force is simply given as the shear strength multiplied by the area. The pressure build-up in any rotational extruder is thus fundamentally different for polymers and metals.

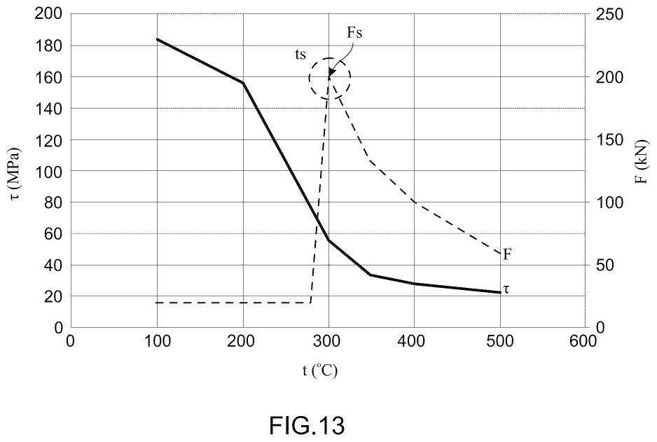

FIG. 13 illustrates how friction force F and shear strength τ in a metal vary with temperature in a metal during mixing and compaction. The shear strength τ generally decreases with increasing temperature, and the friction force F remains constant until sticking friction occurs at a temperature t_{S}, which is the material-dependent critical temperature for sticking friction. In the illustrated example, in which the material is aluminium, sticking friction F_{S} is achieved at a temperature ts of 300° C.

An element (such as a metal) which is being forced along bore in an extruder by means of a rotating member, is subjected to a positive pressure gradient in the downstream direction—a fundamental premise for compaction and subsequent extrusion. This is the case for a conventional screw extruder having a rotating screw inside a substantially smooth bore (barrel), as well as for the extruder according to the present invention as described above. While the affected area, i.e. geometrical and dimensional relationship between the screw and the bore is important, it can be demonstrated that an absolute requirement for a positive pressure gradient in the downstream direction is that the shear strength between the element and the rotating member (τ_{R}) is greater than the shear strength between the element and the static member (τ_{S}), i.e.: τ_{R}>τ_{S}. For example, a ratio of τ_{R}/τ_{S} between 1.5 and 3.0 seems favourable, depending on the alloy.

Therefore, to control the pressure build-up for “rotational extrusion” of metals (as opposed to non-rotational ram extrusion), one must control the shear strength of the metal at the different surfaces in the extruder. The term “rotational extrusion” is used for indicating that this principle applies to a conventional screw extruder and any extruder using a rotating member for advancing the element to be extruded. By utilizing the fact that the shear strength of a metal is temperature-dependent, it is possible to use temperature as the control mechanism for pressure generation. The temperature in the rotating screw is thus balanced against the temperature in the static bore wall in order to achieve sticking friction between the material and the punch and reduce friction between the material and the bore wall.

Therefore, the invented method comprises controlling the temperature in the screw (t_{R}) and the temperature in the wall of the bore (t_{B}) while the screw is rotating such that the temperature in the screw is higher than the temperature of the wall of the bore; i.e. t_{R}>t_{B}. Also, the method comprises allowing at least the temperature in the wall of the bore (t_{B}) to rise to a level at or above the sticking friction temperature (t_{S}) for the material or materials to be extruded in the upstream end of the bore 16, while maintaining the temperature in the screw above the temperature of the wall of the bore; i.e. t_{R}>t_{B}.

It should be understood that the invention applies to extrusion of materials with high viscosity, for example metals such as aluminium, aluminium alloys, or metal matrix composites. The extrusion process may be continuous or by introducing batches of material or material mixtures into the extruder.

In the embodiments described above, various features and details are shown in combination. The fact that several features are described with respect to a particular example should not be construed as implying that those features by necessity have to be included together in all embodiments of the invention. Conversely, features that are described with reference to different embodiments should not be construed as mutually exclusive. As a person skilled in the art readily will understand, embodiments that incorporate any subset of features described herein and that are not expressly interdependent have been contemplated by the inventor and are part of the intended disclosure. However, explicit description of all such embodiments would not contribute to the understanding of the principles of the invention, and consequently some permutations of features have been omitted for the sake of simplicity or brevity. The invention is defined by the appended claims.

1. A screw extruder for extrusion of materials with high viscosity, comprising a screw rotationally arranged in a bore within a housing,
wherein the housing comprises:
a base section having an inlet configured for feeding a material to be compacted and extruded into the screw extruder; and
an extrusion section having a compacting chamber and an extrusion die opening,
wherein the screw extruder further comprises a plurality of transport and compaction sections arranged between the base section and the extrusion section, and
wherein housing sections, comprising the base section, the plurality of transport and compaction sections, and the extrusion section, are releasably interconnected in an end-to-end relationship.

2. The screw extruder of claim 1, wherein at least one gap is provided between at least two adjacent housing sections, wherein the at least one gap comprises a void or holds an insulating material, configured to limit a heat transfer between the at least two adjacent housing sections.

3. The screw extruder of claim 2, wherein the at least one gap holds an element having a thermal conductivity equal to or greater than a thermal conductivity of the material in the housing sections, configured to enhance the heat transfer between the at least two adjacent housing sections.

4. The screw extruder of claim 1, wherein at least one housing section of the housing sections comprises one or more fluid conduits and one or more fluid connectors configured for connection to a fluid supply and circulation system, whereby the at least one housing section is configured such that a temperature in the at least one housing section is controlled individually.

5. The screw extruder of claim 4, wherein the one or more fluid conduits are embedded in the at least one housing section.

6. The screw extruder of claim 1, wherein at least one transport and compaction section of the plurality of transport and compaction sections comprises an outer body having an internal liner arranged in an internal bore of the outer body, and wherein at least a portion of the bore is formed in the internal liner.

7. The screw extruder of claim 6, wherein a material of the internal liner has a thermal conductivity greater than a thermal conductivity of a material of the outer body.

8. The screw extruder of claim 6, wherein the internal liner is secured to the outer body whereby the internal liner is prevented from rotating inside the outer body.

9. The screw extruder of claim 8, wherein an inner surface the outer body and an outer surface of the internal liner comprise complementary shapes.

10. The screw extruder of claim 9, wherein the inner surface of the outer body and the outer surface the internal liner comprises complementary frustoconical shapes with a common cone angle (α), and the internal liner comprises a frustrum with a base of the frustrum arranged on a downstream side (D) of the at least one transport and compaction section.

11. The screw extruder of claim 6, wherein outer surface of the internal liner comprises a helical groove that forms a fluid conduit when an insert is arranged in the outer body, and wherein channels terminating in external fluid connectors are formed in the outer body and aligned with respective ends of the helical groove when the insert is arranged in the outer body.

12. A method for controlling extrusion pressure in a screw extruder for extrusion of a material or materials with high viscosity,
wherein the screw extruder comprises a screw rotationally arranged in a bore within a housing, and
wherein the method comprises:
controlling a temperature in the screw (t_{R}) and a temperature in a wall of the bore (t_{B}) while the screw is rotating and the material or materials are within a mixing-and-compaction zone in the screw extruder, such that the temperature in the screw is higher than the temperature of the wall of the bore (t_{R}>t_{B}).

13. The method of claim 12, wherein the method further comprises allowing at least the temperature in the wall of the bore (t_{B}) to rise to a level at or above a sticking friction temperature (t_{S}) for a material or materials to be extruded, at a beginning of the mixing-and-compaction zone, while maintaining the temperature in the screw above the temperature of the wall of the bore (t_{R}>t_{B}).

14. The method of claim 12, wherein the housing comprises:
a base section having an inlet configured for feeding a material to be compacted and extruded into the screw extruder; and
an extrusion section having a compacting chamber and an extrusion die opening,
wherein the screw extruder further comprises a plurality of transport and compaction sections arranged between the base section and the extrusion section, and
wherein housing sections, comprising the base section, the plurality of transport and compaction sections, and the extrusion section, are releasably interconnected in an end-to-end relationship.

15. The method of claim 14, further comprising controlling the a temperature in each housing section of the housing sections individually, by circulating a fluid in at least one fluid conduit in a respective housing section,
wherein the fluid comprises a cooling liquid and a temperature of the cooling liquid fed into the at least one fluid conduit is based on one or more temperatures sensed in the respective housing section.

16. The screw extruder of claim 1, wherein the materials with high viscosity comprise aluminium, aluminium alloys, or other metal matrix composites or alloys.

17. The method of claim 12, wherein the material or materials with high viscosity comprises aluminium, aluminium alloys, or other metal matrix composites or alloys.
